(19) United States
(12) Patent Application Publication
(10) Pub. No.: US 2024/0054679 A1
(43) Pub. Date: Feb. 15, 2024

(54) METHOD AND APPARATUS FOR MANAGING CAMERA SYSTEM

(71) Applicant: ABB Schweiz AG, Baden (CH)

(72) Inventors: Wenzhou Yan, Shanghai (CN); Tongshuai Zhu, Shanghai (CN); Hao Chen, Shanghai (CN); Lun Jiang, Shanghai (CN); Xiaodi Yu, Shanghai (CN)

(73) Assignee: ABB Schweiz AG, Baden (CH)

(21) Appl. No.: 18/266,778

(22) PCT Filed: Dec. 29, 2020
(86) PCT No.: PCT/CN2020/140856

§ 371 Date: Jun. 12, 2023

(51) Int. Cl. G06T 7/80

(52) U.S. Cl. CPC G06T 7/80; G06T 2207/30244; G06T 2207/30108

(57) ABSTRACT

Methods, apparatuses, systems, and computer readable media for managing a camera system. The camera system comprises at least a first camera and a second camera. In the method, a first position and a second position for a first object and a second object are obtained from the first and second cameras, respectively. The first and second objects are used for calibrating the camera system. After a movement of the first and second objects, a third position and a fourth position for the first and second objects are obtained from the first and second cameras, respectively. Here, a relative object position between the first and second objects remains unchanged during the movement. A relative camera position between the first and second cameras is determined based on the first, second, third, and fourth positions.

### FIELD

Example embodiments of the present disclosure generally relate to camera management, and more specifically, to methods, apparatuses, systems and computer readable media for managing a camera system that is deployed in a robot system.

### BACKGROUND

With the development of computer and automatic control, robot systems have been widely used to process various types of objects in the manufacturing industry. For example, a tool may be equipped at a tip of a robot system for cutting, grabbing and other operations. Typically, the robot system may have a plurality of mechanical arms, each of which may be rotated by a corresponding joint at an end of the arm. A camera system may be deployed in the robot system for monitoring an operation of the robot system. Usually, a field of view of a single camera cannot cover an entire workspace of the robot system, therefore multiple cameras are provided in the camera system to collect images of various areas in the workspace. Further, these images may be merged for monitoring the robot system. At an initial stage of the robot system, the camera system should be calibrated such that images collected by these cameras may be properly merged for further processing.

There have been proposed several solutions for calibrating the camera system based on a calibrating board. However, with the increasing scale of the workspace, cameras may be distributed across a wide area. Therefore, a size of the calibrating board also increases. It is understood that the calibrating board is required to be manufactured at a very high accuracy and even a slight error in the accuracy may cause a huge deviation in the calibrating. However, compared with a small calibrating board, it is more difficult to ensure a high manufacturing accuracy for a huge calibrating board. Therefore, it is desired to propose a more efficient solution for calibrating the camera system.

### SUMMARY

Example embodiments of the present disclosure provide solutions for managing a camera system.

In a first aspect, example embodiments of the present disclosure provide a method for managing a camera system, the camera system comprising at least a first camera and a second camera. Here, the method comprises: obtaining a first position and a second position for a first object and a second object from the first and second cameras, respectively, the first and second objects being used for calibrating the camera system; obtaining, after a movement of the first and second objects, a third position and a fourth position for the first and second objects from the first and second cameras, respectively, a relative object position between the first and second objects remaining unchanged during the movement; and determining a relative camera position between the first and second cameras based on the first, second, third, and fourth positions. With these embodiments, the first and second cameras in the camera system may be calibrated by the two individual calibrating objects. The two objects may have small sizes with high accuracies and the only requirement is that the relative object position between the two objects remains unchanged during the movement. At this point, the calibrating procedure does not require a huge calibrating board that covers fields of view of all the cameras, instead the two individual calibrating objects may be used to replace the huge calibrating board as along as the relative object position is fixed. Compared with a huge calibrating board, the two calibrating objects may be small and have high manufacturing accuracy. Therefore, the calibrating procedure may be implemented in a more convenient and effective way.

In some embodiments, determining the relative camera position comprises: generating an equation associated with the relative camera position, the first, second, third, and fourth positions based on a geometry relationship between the first and second objects and the first and second cameras; and determining the relative camera position by solving the equation. As the first, second, third and fourth positions are easily to be detected and thus the problem for determining the relative camera position may be converted into a problem of solving the equation. Compared with calibrating the camera system by a huge physical calibrating board, the two small calibrating objects with high accuracies provide a more effective calibrating way based on mathematical operations.

In some embodiments, solving the equation comprising: representing the relative camera position by a transformation matrix including a plurality of unknown parameters; generating a group of equations including the plurality of unknown parameters based on the equation; and determining the plurality of unknown parameters based by solving the group of equations. With these embodiments, the relative camera position may be represented by an RT transformation matrix including twelve unknown parameters. Further, based on a mathematical relationship for the matrix multiplication, the one equation may be extended to a group of equations associated with the twelve unknown parameters. Further, the twelve unknown parameters may be easily determined based on the mathematical operation, and thus the relative camera position may be obtained.

In some embodiments, the first and second objects are connected with a fixed connection such that the relative object position remains unchanged during the movement. In these embodiments, the first and second objects may be in various shapes as along as feature points in these objects may reflect degree of freedom (DOF) for the objects. With these embodiments, the first and second objects may be connected with various types of connections as along as the first and second objects may move together and their relative object position remains unchanged. Compared with manufacturing a huge calibrating board with the high accuracy, connecting the two individual objects with a fixed connection is much simple and convenient.

In some embodiments, the first object is placed within a first field of view of the first camera, and the second object is placed within a second field of view of the second camera. Here, embodiments of the present disclosure do not require a huge calibrating object to cover fields of view of all the cameras. Instead, the calibrating object of the present disclosure may be in a small size such that the manufacturing accuracy for the calibrating object may be ensured in an easier manner.

In some embodiments, obtaining the first position comprises: obtaining a first image for the first object from the first camera; and determining the first position from the first image, the first position representing a relative position between the first object and the first camera. Nowadays, various types of camera are capable of providing distance measurements. For example, some cameras are equipped with laser devices that may detect the position of the object directly. In another example, the position of the object may be calculated based on processing the image of the object. With these embodiments, all inputs for determining the relative camera position may be collected in an effective and convenient way.

In some embodiments, the camera system further comprises a third camera, and the method further comprises: obtaining a fifth position for a third object from the third camera, the third object being used for calibrating the camera system; obtaining, after a movement of the third object together with the first and second objects, a six position for the third from the third camera, a relative object position between third object and any of the first and second objects remaining unchanged during the movement; and determining a relative camera position between the first and third cameras based on the first, fifth, third, and sixth positions. The above embodiments may be easily extended for managing multiple cameras. Specifically, the number of the calibrating objects may be determined based on the number of the to-be-calibrated cameras. By connecting the third object to the first object or the second object and move these objects together, all the three cameras may be calibrated in a simple and effective way. Therefore, more cameras may be added into the camera system, and the added camera may be calibrated with other existing cameras in an easy and effective way.

In some embodiments, the method further comprises: calibrating the camera system based on the relative camera position. As the small calibrating objects are easily to be manufactured with the high accuracy, the high manufacturing accuracy may ensure a high accuracy for the relative camera position. Accordingly, the first and second cameras may be calibrated on the basis of the accurate relative camera position.

In some embodiments, the camera system is deployed in a robot system, and the method further comprises: monitoring an operation of the robot system based on the calibrated camera system. The robot system may include multiple robot arms that move at high speeds. In order to increase the accuracy of movements of these robot arms, more cameras may be deployed in the robot system. For example, a new camera may be deployed at a position that is far from other cameras. At this point, the entire camera system may be calibrated by adding a new object to the existing objects, in turns, the accuracy of the robot system may be increased accordingly.

In a second aspect, example embodiments of the present disclosure provide an apparatus for managing a camera system, the camera system comprising at least a first camera and a second camera, the apparatus comprising: a first obtaining unit, being configured to obtain a first position and a second position for a first object and a second object from the first and second cameras, respectively, the first and second objects being used for calibrating the camera system; a second obtaining unit, being configured to obtain, after a movement of the first and second objects, a third position and a fourth position for the first and second objects from the first and second cameras, respectively, a relative object position between the first and second objects remaining unchanged during the movement; and a determining unit, being configured to determine a relative camera position between the first and second cameras based on the first, second, third, and fourth positions.

In some embodiments, the determining unit comprises: a generating unit, being configured to generate an equation associated with the relative camera position, the first, second, third, and fourth positions based on a geometry relationship between the first and second objects and the first and second cameras; and a solving unit, being configured to determine the relative camera position by solving the equation.

In some embodiments, the solving unit comprises: a representing unit, being configured to represent the relative camera position by a transformation matrix including a plurality of unknown parameters; and an equation generating unit, being configured to generate a group of equations including the plurality of unknown parameters based on the equation; and a parameter determining unit, being configured to determine the plurality of unknown parameters by solving the group of equations.

In some embodiments, the first and second objects are connected with a fixed connection such that the relative object position remains unchanged during the movement.

In some embodiments, the first object is placed within a first field of view of the first camera and the second object is placed within a second field of view of the second camera.

In some embodiments, the first obtaining unit comprises: an image obtaining unit, being configured to obtain a first image for the first object from the first camera; and a position determining unit, being configured to determine the first position from the first image, the first position representing a relative position between the first object and the first camera.

In some embodiments, the camera system further comprises a third camera, and the first obtaining unit being further configured to obtain a fifth position for a third object from the third camera, the third object being used for calibrating the camera system; the second obtaining unit being further configured to obtain, after a movement of the third object together with the first objects, a six position for the third object from the third camera, a relative object position between third object and any of the first and second objects remaining unchanged during the movement; and the determining unit being further configured to determine a relative camera position between the first and third cameras based on the first, fifth, third, and sixth positions.

In some embodiments, the apparatus further comprises: a calibrating unit, being configured to calibrate the camera system based on the relative camera position.

In some embodiments, the camera system is deployed in a robot system and the apparatus further comprises: a monitoring unit, being configured to monitor an operation of the robot system based on the calibrated camera system.

In a third aspect, example embodiments of the present disclosure provide a system for managing a camera system. The system comprises: a computer processor coupled to a computer-readable memory unit, the memory unit comprising instructions that when executed by the computer processor implements the method for managing a camera system.

In a fourth aspect, example embodiments of the present disclosure provide a computer readable medium having instructions stored thereon, the instructions, when executed on at least one processor, cause the at least one processor to perform the method for managing a camera system.

### DESCRIPTION OF DRAWINGS

FIG. 1 illustrates a schematic diagram for a robot system in which embodiments of the present disclosure may be implemented;

FIG. 2 illustrates a schematic diagram of a procedure for calibrating a camera system based on a calibrating board;

FIG. 3 illustrates a schematic diagram of a procedure for managing a camera system in accordance with embodiments of the present disclosure;

FIG. 4 illustrates a schematic diagram of a method for managing a camera system in accordance with embodiments of the present disclosure;

FIG. 5 illustrates a schematic diagram of a geometry relationship between a first object, a second object, a first camera, and a second camera in accordance with embodiments of the present disclosure;

FIG. 6 illustrates a schematic diagram for a geometry relationship between the first and second objects and the first and second cameras in accordance with embodiments of the present disclosure;

FIG. 7 illustrates a schematic diagram of a procedure for calibrating a camera system in accordance with embodiments of the present disclosure;

FIG. 8 illustrates a schematic diagram of an apparatus for calibrating a camera system in accordance with embodiments of the present disclosure; and

FIG. 9 illustrates a schematic diagram of a system for calibrating a camera system in accordance with embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

For the sake of description, reference will be made to FIG. 1 to provide a general description of environment of the present disclosure. FIG. 1 illustrates a schematic diagram for a robot system 100 in which embodiments of the present disclosure may be implemented. In FIG. 1, the robot system 100 may comprise a camera system 160 for monitoring operations for the robot system 100. As illustrated, the camera system may include a first camera 110 and a second camera 120 for collecting images of a target object 150. The robot system 100 may comprise at least one arms 140, 142, . . . , and 144.

A tip of the end arm 144 may be equipped with a tool 130 for processing the target object 150 such as a raw material that is to be shaped by the robot system 100. Here, the tool may include, for example, a cutting tool for shaping the target object 150 into a desired shape. Before normal operations of the robot system 100, the camera system should be calibrated first, such that images collected by the first and second cameras 110 and 120 may be merged for further processing.

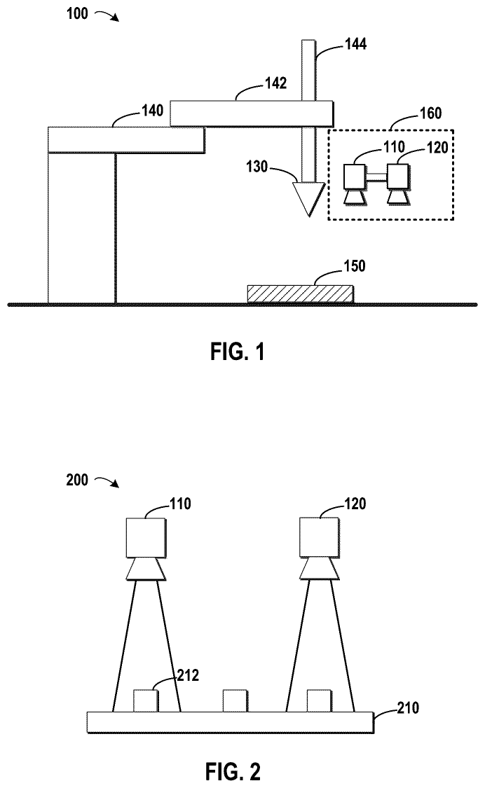

There have been proposed solutions for calibrating the camera system of the robot system. In some solutions, a calibrating board is used for calibration and reference will be made to FIG. 2 for a brief description of the calibrating procedure. FIG. 2 illustrates a schematic diagram 200 of a procedure for calibrating a camera system based on a calibrating board. In FIG. 2, a calibrating board 210 is placed towards the first and second cameras 110 and 120. Here, the calibrating board 210 may include multiple features that may identify various DOFs for calibrating the camera system. For example, the feature 212 may include a cube, a cuboid, or another shape. Although the calibrating board 210 is in three dimensions, the calibrating board 210 may be in a two dimension shape such as a checkerboard.

Usually, the calibrating board 210 is selected based on a distance between the first and second cameras 110 and 120. The far the distance is, the larger the size of the calibrating board 210 is. If the first and second cameras 110 and 120 are far from each other, then a huge calibrating board should be selected for the calibrating procedure. However, the calibrating board requires the high manufacture accuracy, and the bigger the calibrating board is, the more difficult it is to manufacture. Therefore, a huge calibrating board is hard to be made and it is difficult to ensure the manufacturing accuracy of the huge calibrating board. Further, the robot system 100 may include multiple camera systems with different camera distances, therefore multiple calibrating boards with different sizes should be prepared.

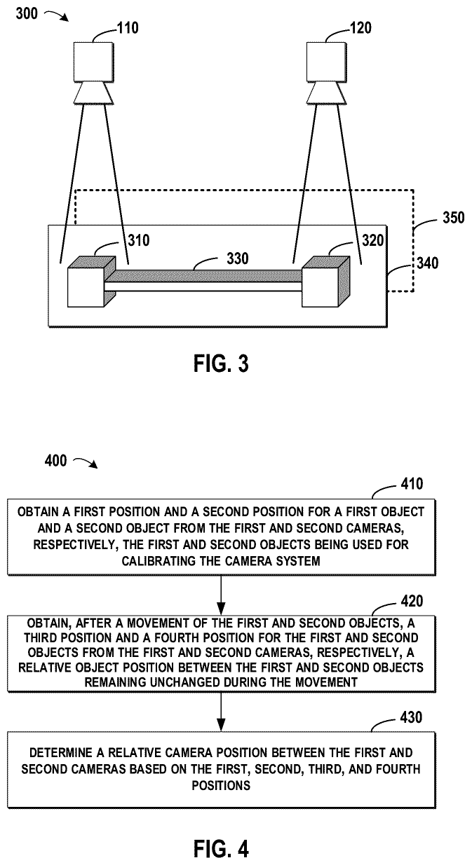

In order to at least partially solve the above and other potential problems, a new method for managing a camera system is provided according to embodiments of the present disclosure. In general, according to embodiments of the present disclosure, multiple calibrating objects are provided for the calibrating procedure. Reference will be made to FIG. 3 for a brief description of the present disclosure. FIG. 3 illustrates a schematic diagram 300 of a procedure for managing a camera system in accordance with embodiments of the present disclosure. In FIG. 3, a first object 310 and a second object 320 are deployed within fields of views of the first and second cameras 110 and 120, respectively. Here, the first and second objects 310 and 320 may be individual objects in small shapes, and the two individual objects may be connected via a fixed connection 330. To calibrate the first and second cameras 110 and 120, a relative camera position should be determined first.

In FIG. 3, positions of the first and second objects 310 and 320 may be determined before and after a movement of the first and second objects 310 and 320. For example, the first and second objects 310 and 320 may be placed in a position 340 before the movement, and a first position and a second position may be determined for the first and second objects from the first and second cameras, respectively. Then, the first and second objects 310 and 320 may be moved to a position 350. During the movement, a relative object position between the first and second objects 310 and 320 remains unchanged. A third position and a fourth position for the first and second objects 310 and 320 may be determined from the first and second cameras 110 and 120, respectively. Further, the relative camera position may be determined based on the first, second, third, and fourth positions.

With these embodiments, the relative camera position may be determined by two individual calibrating objects. Therefore, the calibrating procedure does not require a huge calibrating board that covers fields of view of all the cameras. Instead the two calibrating objects may be connected by any way as along as their relative position is fixed. Compared with the huge calibrating board, the first and second objects 310 and 320 may be small in size and having a higher manufacturing accuracy. Therefore, the relative camera position may be implemented in a more convenient and effective way.

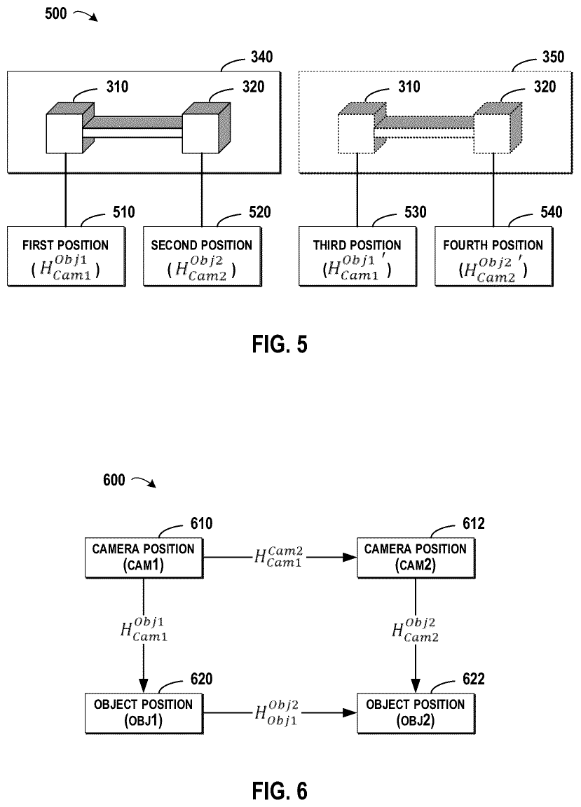

Reference will be made to FIG. 4 for more details about the present disclosure. FIG. 4 illustrates a schematic diagram 400 of a method for calibrating a camera system in accordance with embodiments of the present disclosure. At a block 410, a first position and a second position for the first object 310 and the second object 320 are obtained from the first and second cameras 110 and 120, respectively. Here, the first and second objects 310 and 320 are used for calibrating the camera system. Hereinafter, reference will be made to FIG. 5 for more details for obtaining the first and second positions.

FIG. 5 illustrates a schematic diagram 500 of a geometry relationship between a first object 310, a second object 320, a first camera 110, and a second camera 120 in accordance with embodiments of the present disclosure. In FIG. 5, the first object 310 may be placed within a first field of view of the first camera 110, and the second object 320 may be placed within a second field of view of the second camera 120. Here, embodiments of the present disclosure do not require one individual calibrating object to cover fields of view of all the cameras. In other words, one camera only needs to capture one object, and thus both of the first and second objects 310 and 320 may be relatively small, such that the manufacturing accuracy for the two calibrating objects may be easily to ensure. In these embodiments, the first and second objects may be in various shapes as along as feature points in these objects may reflect multiple aspects of DOFs of the objects.

Although the above paragraph describe that the first object 310 is placed in the field of view of the first camera 110, it does not exclude a situation that a portion of or all of the second object 320 is also within the field of view of the first camera 110. Therefore, the size of the first and second objects 310 and 320 may be selected in a causal way. For example, the first and second objects 310 and 320 may be in the same size, in different sizes, in the same shape, or in different shapes. In these embodiments, the only requirement is that the first and second objects 310 and 320 are connected in a fixed manner such that the two objects move together and the relative object position therebetween remains unchanged during the movement.

As illustrated in FIG. 5, initially, the first and second objects 310 and 320 may be placed in the position 340, then a first position 510 (represented by H_{Cam1}^{Wobj1}) may be obtained for the first object 310, and a second position 520 (represented by H_{Cam2}^{Wobj2}) may be obtained for the second object 320. Here, steps for obtaining the first and second position 510 and 520 are similar and the following paragraph will describe how to obtain the first position 510. In some embodiments, a first image may be collected for the first object 310 by the first camera 110, and the first position 510 represents a relative position between the first object 310 and the first camera 110.

Nowadays, various types of camera have functions for distance measurement. For example, some cameras are equipped with laser devices that may detect the position of the object directly. Specifically, a laser beam may be transmitted from a transceiver in the camera to the object, and then the position of the object may be determined based on a time point when the laser beam is transmitted and a time point when a reflected beam returns back to the transceiver. In another example, for some cameras that do not have a laser device, the position of the object may be calculated based on processing the image of the object. For example, pixels for features (such as corners in a cube object) may be identified from the image and then the position of the object may be determined. With these embodiments, the positions of the first and second objects 310 and 320 may be collected in an effective and convenient way. Having described the determination of the first position 510, other positions may be determined in a similar manner. For example, the second position 520 may be determined from an image for the second object 320 that is captured by the second camera 120.

Referring back to FIG. 4, after the first and second positions 510 and 520 are obtained, the first and second objects 310 and 320 may be moved to the position 350. Here, the first and second objects 310 and 320 are connected with a fixed connection such that the relative object position remains unchanged during the movement. Various methods may be used to connect the first and second objects 310 and 320. In some embodiments, the first and second objects 310 and 320 may be connected with a rigid connection 330 such as a rod, a pin, a bolt, and the like. In some embodiments, the first and second objects 310 and 320 may be bonded together with adhesive and the like. Alternatively and/or in addition to, the first and second objects 310 and 320 may be fixed to a rigid frame which ensures that the relative object position between the two objects remains unchanged during movements.

With these embodiments, the first and second objects 310 and 320 may be connected with various types of connections as along as the two objects may move together and the relative object position remains unchanged. Compared with producing a huge calibrating board with the high accuracy, connecting the two individual objects with a fixed connection is much simple and convenient.

At a block 420 in FIG. 4, after a movement of the first and second objects 310 and 320, a third position 530 and a fourth position 540 for the first and second objects 310 and 320 are obtained from the first and second cameras 110 and 120, respectively. In these embodiments, it is required that the first and second objects 310 and 320 should be within the fields of views of the first and second cameras 110 and 120 after the movement, such that the two cameras may still capture images for the two objects, respectively. Referring to FIG. 5 again, the third position 530 (represented by H_{Cam1}^{Wobj1′}) may be obtained from the image captured by the first camera 110, and the fourth position 540 (represented by H_{Cam2}^{Wobj2′}) may be obtained from the image captured by the second camera 130. Here, the third position 530 represents a relative position between the first object 310 and the first camera 110 after the movement, and the fourth position 540 represents a relative position between the second object 320 and the second camera 120 after the movement.

Referring back to a block 430 in FIG. 4, a relative camera position between the first and second cameras 110 and 120 is determined based on the first, second, third, and fourth positions (510, 520, 530 and 540). Here, a geometry relationship exists between the first and second objects 310 and 320 and the first and second cameras 110 and 120. Reference will be made to FIG. 6 for further details.

FIG. 6 illustrates a schematic diagram for a geometry relationship 600 between the first and second objects 310 and 320 and the first and second cameras 110 and 120 in accordance with embodiments of the present disclosure. In FIG. 6, a camera position 610 and a camera position 612 represent positions of the first and second cameras 110 and 120 in a world coordinate system, and an object position 620 and an object position 622 represent positions of the first and second objects 310 and 320 in the world coordinate system. H_{Cam1}^{Cam2} represents a transformation matrix for the relative camera position between the second camera 120 and first camera 110, and H_{Ojb1}^{Obj2} represents a transformation matrix for the relative object position between the second object 320 and the first object 310. Based on arrows between the above positions 610 to 640, the following Equation 1 may be determined:

(H_{Cam1}^{Obj1})⁻¹·H_{Cam1}^{Cam2}·H_{Cam2}^{Obj2}=H_{Obj1}^{Obj2} Equation 1

Where H_{Cam1}^{Obj1} represents a relative position between the first object 310 and the first camera 110, H_{Cam1}^{Cam2} represents a transformation matrix for the relative camera position between the second camera 120 and first camera 110, H_{Cam2}^{Obj2} represents a relative position between the second object 320 and the second camera 120, and H_{Obj1}^{Obj2} represents a transformation matrix for the relative object position between the second object 320 and the first object 310.

It is to be understood that the above Equation 1 may always work during movements of the first and second objects 310 and 320. Accordingly, the above geometry relationship between the first and second objects and the first and second cameras may be used to generate an equation associated with the relative camera position, the first, second, third, and fourth positions (510, 520, 530, and 540). Specifically, another Equation 2 may be obtained for those positions obtained after the movement.

(H_{Cam1}^{Obj1′})⁻¹·H_{Cam1}^{Cam2}·H_{Cam2}^{Obj2′}=H_{Obj1}^{Obj2} Equation 2

Where H_{Cam1}^{Obj1′} represents a relative position between the first object 310 and the first camera 110 after the movement, H_{Cam1}^{Cam2} represents a transformation matrix for the relative camera position between the second camera 120 and first camera 110, H_{Cam2}^{Obj2′} represents a relative position between the second object 320 and the second camera 120 after the movement, and H_{Obj1}^{Obj2} represents a transformation matrix for the relative object position between the second object 320 and the first object 310.

It is to be noted that the positions of the first and second cameras 110 and 120 are unchanged, and thus the relative camera position H_{Cam1}^{Cam2} in Equations 1 and 2 have the same value. Further, the first and second objects 310 and 320 move together and thus the relative object position H_{Obj1}^{Obj2} in Equations 1 and 2 have the same value. Accordingly, right sides of the Equations 1 and 2 have the same value and thus the two equations may be combined into the following Equation 3.

(H_{Cam1}^{Obj1})⁻¹·H_{Cam1}^{Cam2}·H_{Cam2}^{Obj2}=(H_{Cam1}^{Obj1′})⁻¹·H_{Cam1}^{Cam2}·H_{Cam2}^{Obj2′} Equation 3

Symbols in Equation 3 have the same meanings as those in the above Equations 1 and 2. In Equation 3, H_{Cam1}^{Obj1}, H_{Cam2}^{Obj2}, H_{Cam1}^{Obj1′}, and H_{Cam2}^{Obj2′} have known values (i.e., the first, second, third and fourth positions 510 to 540 as determined in FIG. 5), while H_{Cam1}^{Cam2} is unknown. In these embodiments, the above positions 510 to 540 are easily detected and thus the problem for determining the relative camera position H_{Cam1}^{Cam2} may be converted into a problem of solving the Equation 3. Compared with calibrating the camera system by a huge physical calibrating board with a higher accuracy, the camera system may be calibrated by multiple small calibrating objects based on a mathematical operation in a more effective way.

In some embodiments, symbols in Equation 3 may be donated in a form of a RT matrix

$$[ \begin{matrix}R & T \\ 0 & 1\end{matrix} ] ,$$

where R donates a 3*3 rotating matrix, and T donates a 3*1 column vector. As H_{Cam1}^{Obj1}, H_{Cam2}^{Obj2}′, H_{Cam1}^{Obj1′}, and H_{Cam2}^{Obj2′} in Equation 3 have known values, parameters in the RT matrix for H_{Cam1}^{Obj1}, H_{Cam2}^{Obj2}, H_{Cam1}^{Obj1′}, and H_{Cam2}^{Obj2′} are known. Regarding to the only unknown value, H_{Cam1}^{Cam2} may be donated by a RT matrix

$$[ \begin{matrix}R & T \\ 0 & 1\end{matrix} ]$$

that including twelve unknown parameters, where R may be donated by

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

and T may be donated by

$$[ \begin{matrix}{t}_{1} \\ {t}_{2} \\ {t}_{3}\end{matrix} ] .$$

Accordingly, the unknown relative camera position H_{Cam1}^{Cam2} may be represented a transformation matrix including the twelve unknown parameters: r₁₁, r₁₂, r₁₃, r₂₁, r₂₂, r₂₃, r₃₁, r₃₂, r₃₃, t₁, t₂ and t₃ as below:

$${H}_{Cam 1}^{Cam 2} = [ \begin{matrix}R & T \\ 0 & 1\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] \qquad Equation 4$$

Further, based on Equations 3 and 4, the following Equation 5 may be determined:

$${( {H}_{Cam 1}^{Obj 1} )}^{- 1} \cdot [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] \cdot {H}_{Cam 2}^{Obj 2} = {( {H}_{Cam 1}^{Obj {1}^{′}} )}^{- 1} \cdot [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] \cdot {H}_{Cam 2}^{Obj {2}^{′}} \qquad Equation 5$$

By moving the right side in Equation 5 to the left side, Equation 5 may be converted to Equation 6:

$${( {H}_{Cam 1}^{Obj 1} )}^{- 1} \cdot [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] \cdot {H}_{Cam 2}^{Obj 2} - {( {H}_{Cam 1}^{Obj {1}^{′}} )}^{- 1} \cdot [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] \cdot {H}_{Cam 2}^{Obj {2}^{′}} = 0 \qquad Equation 6$$

In Equation 6, each of H_{Cam1}^{Obj1}, H_{Cam2}^{Obj2}, H_{Cam1}^{Obj1′}, and H_{Cam2}^{Obj2′} may be represented by an individual RT matrix with 16 (4*4) known parameters. Further, based on mathematical definitions of matrix multiplication, the above Equation 6 may be expended to a group of equations including the plurality of unknown parameters. Specifically, each of the group of equations may be associated with some of the 12 unknown members r₁₁, r₁₂, r₁₃, r₂₁, r₂₂, r₂₃, r₃₁, r₃₂, r₃₃, t₁, t₂ and t₃. As the RT matrix is in form of a 4*4 matrix which includes 16 parameters, parameters at the same position at both sides of the above Equation 6 should have the same value. Therefore, 16 equations associated with the 12 unknown parameters may be represented as below:

$$\{ \begin{matrix}{f}_{1} ( {r}_{11} , {r}_{12} , {r}_{13} , {r}_{21} , {r}_{22} , {r}_{23} , {r}_{31} , {r}_{32} , {r}_{33} , {t}_{1} , {t}_{2} , {t}_{3} ) = 0 \\ {f}_{2} ( {r}_{11} , {r}_{12} , {r}_{13} , {r}_{21} , {r}_{22} , {r}_{23} , {r}_{31} , {r}_{32} , {r}_{33} , {t}_{1} , {t}_{2} , {t}_{3} ) = 0 \\ … \\ {f}_{16} ( {r}_{11} , {r}_{12} , {r}_{13} , {r}_{21} , {r}_{22} , {r}_{23} , {r}_{31} , {r}_{32} , {r}_{33} , {t}_{1} , {t}_{2} , {t}_{3} ) = 0\end{matrix} \qquad Equation Set 1$$

Next, the plurality of unknown parameters may be determined by solving the above Equation Set 1. Here, the above Equation Set 1 may be solved by normal mathematical operations and details will be omitted hereinafter. With these embodiments, the relative camera position may be represented by an RT transformation matrix including twelve unknown parameters. Further, based on a mathematical relationship for the matrix multiplication, the one equation may be converted into a group of equations associated with the twelve unknown parameters. Further, the twelve unknown parameters may be easily determined based on the mathematical operation.

With the above method 300, the engineer only needs to place the two objects towards the two cameras and collect two images. Further, the engineer may move the two objects and then collect two more images. Based on the four images before and after the movement, the relative camera position may be determined effectively.

Although the first and second objects 310 and 320 are moved only once in the above embodiments, in other embodiments of the present disclosure, the two objects may be moved several times and then multiple relative camera positions may be obtained. Further, the multiple relative camera positions may be used to calculate the actual relative camera positions. For example, an average may be determined for the multiple relative camera positions and thus the relative camera position may be determined in a more reliable manner.

In some embodiments, the first and second cameras 110 and 120 may be calibrated based on the relative camera position. As the small calibrating objects are easily to be manufactured to a higher accuracy, therefore the high manufacturing accuracy may lead to an accurate relative camera position. Accordingly, the first and second cameras may be calibrated on the basis of the accurate relative camera position.

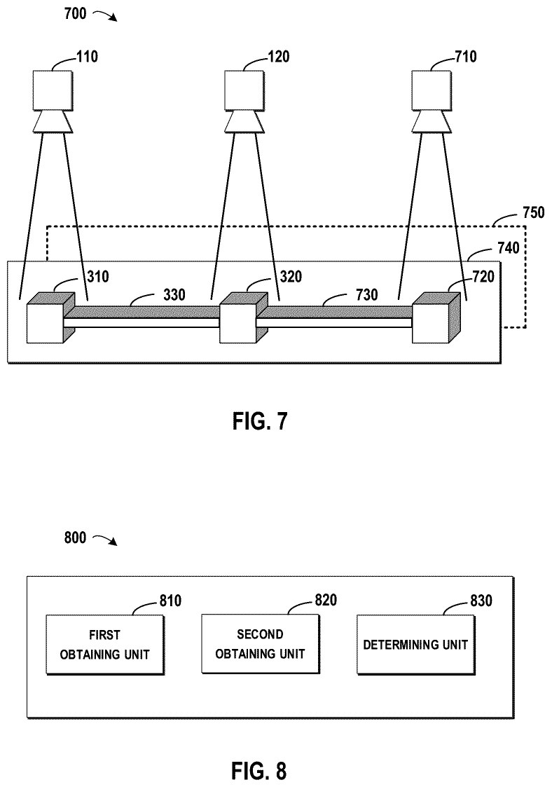

Although the above paragraphs describe the method for calibrating a camera system including two cameras, in some embodiments, the camera system may include more cameras. Hereinafter, reference will be made to FIG. 7 for further descriptions. FIG. 7 illustrates a schematic diagram of a procedure 700 for calibrating a camera system in accordance with embodiments of the present disclosure. As illustrated in FIG. 7, besides the first and second cameras 110 and 120, the camera system may further comprise a third camera 710. In order to calibrating the camera system, a third object 720 may be placed towards the third camera 710. Here, the third object 720 may be connected to any of the first and second objects 310 and 320, as along as the three objects 310, 320 and 720 may move together and relative object positions among them remain unchanged during movements.

In some embodiments, the above method 300 may be implemented to any two cameras in the multiple cameras. For example, the method 300 may be implemented to the first and third cameras 110 and 710. At this point, a fifth position may be obtained for the third object 720 from the third camera 710. After a movement of the third object 710 together with the first object 310, a six position for the third object 720 may be obtained from the third camera. Here, a relative object position between the third object 720 and any of the first and second objects 310 and 320 remains unchanged during the movement. Further, a relative camera position between the first and third cameras 110 and 710 may be determined based on the first, fifth, third, and sixth positions.

In some embodiments, the above method 300 may be implemented to all of the multiple cameras. As illustrated in FIG. 7, the three objects may be place in the position 740 and three object positions may be determined for the three objects from the three cameras, respectively. Further, the three objects may be moved to a position 750 and then other three object positions may be determined for the three objects from the three cameras, respectively. Based on the six object positions, the relative camera position among the three cameras 110, 120 and 710 may be determined.

The above embodiments may be easily extended for managing multiple cameras. Specifically, the number of the calibrating objects may be determined based on the number of the to-be-calibrated cameras. By connecting the third object to the first object or the second object and move these objects together, all the three cameras may be calibrated in a simple and effective way. By these means, as more cameras are added into the camera system, more objects may be used for calibrating the camera system.

In some embodiments, the camera system may be deployed in a robot system for monitoring an operation of the robot system. The robot system may include multiple robot arms that move at a high speed. In order to increase the accuracy of movements of these robot arms, more cameras may be deployed in the robot system. For example, a new camera may be deployed at a position that is far from other cameras. At this point, a new object may be connected with existing objects and then all the cameras may be calibrated.

In some embodiments, the method 300 may be implemented in a controller of the robot system. Alternatively and/or in addition to, the method 300 may be implemented in any computing device. As along as the first, second, third and fourth positions 510 to 540 are inputted into the computing device, the relative camera position may be outputted for calibrating the camera system.

The preceding paragraphs having described detailed steps of the method 300, in some embodiments of the present disclosure, the method 300 may be implemented by an apparatus 800 for managing a camera system. FIG. 8 illustrates a schematic diagram of an apparatus 800 for managing a camera system in accordance with embodiments of the present disclosure. Here, the camera system comprises at least a first camera and a second camera. As illustrated in FIG. 8, the apparatus 800 may comprise: a first obtaining unit 810, being configured to obtain a first position and a second position for a first object and a second object from the first and second cameras, respectively, the first and second objects being used for calibrating the camera system; a second obtaining unit 820, being configured to obtain, after a movement of the first and second objects, a third position and a fourth position for the first and second objects from the first and second cameras, respectively, a relative object position between the first and second objects remaining unchanged during the movement; and a determining unit 830, being configured to determine a relative camera position between the first and second cameras based on the first, second, third, and fourth positions.

In some embodiments, the determining unit 830 comprises: a generating unit, being configured to generate an equation associated with the relative camera position, the first, second, third, and fourth positions based on a geometry relationship between the first and second objects and the first and second cameras; and a solving unit, being configured to determine the relative camera position by solving the equation.

In some embodiments, the solving unit comprises: a representing unit, being configured to represent the relative camera position by a transformation matrix including a plurality of unknown parameters; and an equation generating unit, being configured to generate a group of equations including the plurality of unknown parameters based on the equation; and a parameter determining unit, being configured to determine the plurality of unknown parameters by solving the group of equations.

In some embodiments, the first and second objects are connected with a fixed connection such that the relative object position remains unchanged during the movement.

In some embodiments, the first object is placed within a first field of view of the first camera and the second object is placed within a second field of view of the second camera.

In some embodiments, the first obtaining unit 810 comprises: an image obtaining unit, being configured to obtain a first image for the first object from the first camera; and a position determining unit, being configured to determine the first position from the first image, the first position representing a relative position between the first object and the first camera.

In some embodiments, the camera system further comprises a third camera, and the first obtaining unit 810 being further configured to obtain a fifth position for a third object from the third camera, the third object being used for calibrating the camera system; the second obtaining unit 820 being further configured to obtain, after a movement of the third object together with the first objects, a six position for the third object from the third camera, a relative object position between third object and any of the first and second objects remaining unchanged during the movement; and the determining unit 830 being further configured to determine a relative camera position between the first and third cameras based on the first, fifth, third, and sixth positions.

In some embodiments, the apparatus 800 further comprises: a calibrating unit, being configured to calibrate the camera system based on the relative camera position.

In some embodiments, the camera system is deployed in a robot system and the apparatus 800 further comprises: a monitoring unit, being configured to monitor an operation of the robot system based on the calibrated camera system.

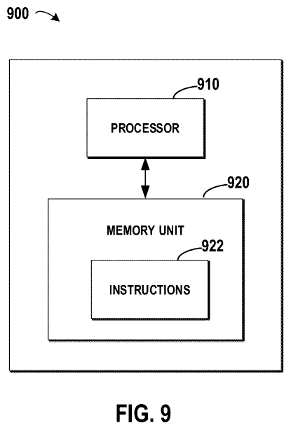

In some embodiments of the present disclosure, a system 900 for managing a camera system is provided. FIG. 9 illustrates a schematic diagram of the system 900 for managing a camera system in accordance with embodiments of the present disclosure. As illustrated in FIG. 9, the system 900 may comprise a computer processor 910 coupled to a computer-readable memory unit 920, and the memory unit 920 comprises instructions 922. When executed by the computer processor 910, the instructions 922 may implement the method for managing a camera system as described in the preceding paragraphs, and details will be omitted hereinafter.

In some embodiments of the present disclosure, a computer readable medium for managing a camera system is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for managing a camera system, the camera system comprising at least a first camera and a second camera, the method comprising:
obtaining a first position and a second position for a first object and a second object from the first and second cameras, respectively, the first and second objects being used for calibrating the camera system;
obtaining, after a movement of the first and second objects, a third position and a fourth position for the first and second objects from the first and second cameras, respectively, a relative object position between the first and second objects remaining unchanged during the movement; and
determining a relative camera position between the first and second cameras based on the first, second, third, and fourth positions.

2. The method of claim 1, wherein determining the relative camera position comprises:
generating an equation associated with the relative camera position, the first, second, third, and fourth positions based on a geometry relationship between the first and second objects and the first and second cameras; and
determining the relative camera position by solving the equation.

3. The method of claim 2, wherein solving the equation comprises:
representing the relative camera position by a transformation matrix including a plurality of unknown parameters;
generating a group of equations including the plurality of unknown parameters based on the equation; and
determining the plurality of unknown parameters by solving the group of equations.

4. The method of claim 1, wherein the first and second objects are connected with a fixed connection such that the relative object position remains unchanged during the movement.

5. The method of claim 1, wherein the first object is placed within a first field of view of the first camera and the second object is placed within a second field of view of the second camera.

6. The method of claim 1, wherein obtaining the first position comprises:
obtaining a first image for the first object from the first camera; and
determining the first position from the first image, the first position representing a relative position between the first object and the first camera.

7. The method of claim 1, wherein the camera system further comprises a third camera, and the method further comprises:
obtaining a fifth position for a third object from the third camera, the third object being used for calibrating the camera system;
obtaining, after a movement of the third object together with the first and second objects, a six position for the third object from the third camera, a relative object position between third object and any of the first and second objects remaining unchanged during the movement; and
determining a relative camera position between the first and third cameras based on the first, fifth, third, and sixth positions.

8. The method of claim 1, further comprising: calibrating the camera system based on the relative camera position.

9. The method of claim 8, wherein the camera system is deployed in a robot system and the method further comprises: monitoring an operation of the robot system based on the calibrated camera system.

10. An apparatus for managing a camera system, the camera system comprising at least a first camera and a second camera, the apparatus comprising:
a first obtaining unit, being configured to obtain a first position and a second position for a first object and a second object from the first and second cameras, respectively, the first and second objects being used for calibrating the camera system;
a second obtaining unit, being configured to obtain, after a movement of the first and second objects, a third position and a fourth position for the first and second objects from the first and second cameras, respectively, a relative object position between the first and second objects remaining unchanged during the movement; and
a determining unit, being configured to determine a relative camera position between the first and second cameras based on the first, second, third, and fourth positions.

11. The apparatus of claim 10, wherein the determining unit comprises:
a generating unit, being configured to generate an equation associated with the relative camera position, the first, second, third, and fourth positions based on a geometry relationship between the first and second objects and the first and second cameras; and
a solving unit, being configured to determine the relative camera position by solving the equation.

12. The apparatus of claim 11, wherein the solving unit comprises:
a representing unit, being configured to represent the relative camera position by a transformation matrix including a plurality of unknown parameters; and
an equation generating unit, being configured to generate a group of equations including the plurality of unknown parameters based on the equation; and
a parameter determining unit, being configured to determine the plurality of unknown parameters by solving the group of equations.

13. The apparatus of claim 10, wherein the first and second objects are connected with a fixed connection such that the relative object position remains unchanged during the movement.

14. The apparatus of claim 10, wherein the first object is placed within a first field of view of the first camera and the second object is placed within a second field of view of the second camera.

15. The apparatus of claim 10, wherein the first obtaining unit comprises:
an image obtaining unit, being configured to obtain a first image for the first object from the first camera; and
a position determining unit, being configured to determine the first position from the first image, the first position representing a relative position between the first object and the first camera.

16. The apparatus of claim 10, wherein the camera system further comprises a third camera, and
the first obtaining unit being further configured to obtain a fifth position for a third object from the third camera, the third object being used for calibrating the camera system;
the second obtaining unit being further configured to obtain, after a movement of the third object together with the first and second objects, a six position for the third object from the third camera, a relative object position between third object and any of the first and second objects remaining unchanged during the movement; and
the determining unit being further configured to determine a relative camera position between the first and third cameras based on the first, fifth, third, and sixth positions.

17. The apparatus of claim 10, further comprising: a calibrating unit, being configured to calibrate the camera system based on the relative camera position.

18. The apparatus of claim 17, wherein the camera system is deployed in a robot system and the apparatus further comprises: a monitoring unit, being configured to monitor an operation of the robot system based on the calibrated camera system.

19. A system for managing a camera system, comprising: a computer processor coupled to a computer-readable memory unit, the memory unit comprising instructions that when executed by the computer processor implements the method according to claim 1.

20. A computer readable medium having instructions stored thereon, the instructions, when executed on at least one processor, cause the at least one processor to perform the method according to claim 1.
